(19) United States
(12) Patent Application Publication
(10) Pub. No.: US 2021/0383372 A1
(43) Pub. Date: Dec. 9, 2021

(54) METHOD AND SYSTEM FOR DELIVERING CONTENT AND CONDUCTING CRYPTOCURRENCY MINING OPERATIONS

(71) Applicant: Jonathan C. Mills, Winter Garden, FL (US)

(72) Inventor: Jonathan C. Mills, Winter Garden, FL (US)

(21) Appl. No.: 17/336,632

(22) Filed: Jun. 2, 2021

Related U.S. Application Data
(60) Provisional application No. 63/034,259, filed on Jun. 3, 2020.
(60) Provisional application No. 63/189,397, filed on May 17, 2021.

(51) Int. Cl. G06Q 20/38; G06Q 20/40; G06F 21/56

(52) U.S. Cl. CPC G06Q 20/389; G06F 21/566; G06Q 20/401

(57) ABSTRACT

A method and system for delivering content to a user and conducting cryptocurrency mining operations includes establishing communication between a platform provider system, a content provider system, a cryptocurrency mining network, and a user interface device. The method includes providing a set of instructions to a content provider to enable cryptocurrency mining on an end user's device. Generating a hybrid offering containing a content component and a mining component. The content component includes content that is exchanged between the user device and the content provider. The mining component includes the set of instructions for utilizing the user interface to conduct mining operations under the control of the provider platform. The method and system also include providing the user with an Application Specific Integrated Circuit (ASIC) that is specifically configured by the platform provider to conduct cryptocurrency mining through the hybrid offerings.

### CROSS-REFERENCE TO RELATED APPLICATIONS

This application claims the benefit of U.S. Application Ser. No. 63/034,259 filed on Jun. 3, 2020 and U.S. Patent Application Ser. No. 63/189,397 filed on May 17, 2021, the contents of which are incorporated herein by reference.

### TECHNICAL FIELD

The following disclosure contemplates various embodiments of systems and methodology for utilizing existing online platforms to conduct cryptocurrency mining and/or blockchain verification activities via end-users of the online platforms.

### BACKGROUND

The statements in this section merely provide background information related to the present disclosure and may not constitute prior art.

Cryptocurrency and blockchain technology were designed to be a disruptive technology to de-centralize current record keeping and banking practices. The process of mining for cryptocurrency such as Bitcoin, for example, involves the process of guessing/solving mathematical equations which results in the release of new coins. Because each of the coins have a market value, it is possible to profit from the mining activities.

In the early days of cryptocurrency, it was possible for individuals to perform mining procedures using their personal computer, wherein they could be rewarded for the time and effort they spent. However, cryptocurrency mining is designed such that it becomes more difficult to solve the equations as more individuals attempt to do so.

As such, much of today's Bitcoin mining and proof of work activities are now monopolized by large companies dedicated to this practice. These companies utilize millions of dollars' worth of computers and Application Specific Integrated Circuits (ASIC's) to conduct cryptocurrency mining, thus making it virtually impossible for the average person to compete and profit. Such actions have resulted in the centralization of Bitcoin and other type of cryptocurrency mining, which goes against the very reason cryptocurrency and blockchain technology were created in the first place.

In a completely separate field of endeavor, there are many types of content providers/entertainment companies such as various gaming sites, video streaming sites, and the like, for example, that provide services to millions of users each day through their own personal computers. As these millions of users play these games, or otherwise access this content, there is a large portion of their computing power that sits idle. Moreover, because the users are receiving services, they typically pay a per-use or monthly subscription fee to the content provider for such service. The combination of a content provider and its users is the very essence of a decentralized network.

With this in mind, the inventor of the presently claimed invention has developed a novel system configuration and method for delivering content to a user while simultaneously conducting cryptocurrency mining using the decentralized network formed by a content provider and its users. More specifically, the method can allow a user's computer to perform mining operations while the user accesses content such as playing a video game or completing an entertainment challenge, for example. Such a system and method acting to decentralize the mining process once again in order to allow ordinary users to profit from such activities.

### SUMMARY OF THE INVENTION

A method and system for delivering content to a user and conducting cryptocurrency mining operations can include establishing communication between a platform provider system, a content provider system, a cryptocurrency mining network, and a user interface device.

The platform provider can provide a set of instructions to a content provider to enable cryptocurrency mining on an end user's device. The content provider can generate a hybrid offering containing a content component and a mining component. The content component can include any type of one way or two-way content that can be exchanged between the user device and the content provider. The mining component can include the set of instructions for utilizing the user interface to conduct mining operations under the control of the provider platform.

The hybrid offering can undergo an approval process by the platform provider and be issued a token or unique key to lock out future changes. In one embodiment, the content and mining operations can be performed simultaneously on the user device such that the content does not conclude until the mining operations have achieved a goal.

In one embodiment, the platform provider can provide the user with an Application Specific Integrated Circuit (ASIC) to be connected to the user interface device. The provided ASIC can be specifically configured by the platform provider to conduct cryptocurrency mining through the hybrid offerings.

Upon conclusion of the mining operations, the platform provider can receive a reward, and can provide payment to each of the content provider and the user. In one embodiment, the user can be paid in a digital currency that is generated by the platform provider and that is different from the cryptocurrency that was mined.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 shows an exemplary network environment according to some embodiments of the technology.

FIG. 2 shows an exemplary flow diagram illustrating a method for delivering content to a user and conducting cryptocurrency mining, according to one embodiment.

FIG. 3 shows an exemplary client management component of the system.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Identical reference numerals are used for like elements of the invention or elements of like function. For the sake of clarity, only those reference numerals are shown in the individual figures which are necessary for the description of the respective figure.

### Definitions

As described throughout this document, the term “content provider” can be used to describe any person, group or legal entity that provides content over a network, such as the internet, for example, that is accessible by others. Several nonlimiting examples of content providers can include, but are not limited to various online gaming sites, gambling sites, informational websites, movie sites, video sites, and/or streaming audio sites, for example.

As described herein, the term “content” can be used to describe any type of one way or two-way digital information that can be exchanged between the content provider and a user. Several nonlimiting examples of content can include, but are not limited to, video games, video files, audio files, text files (e.g., books, articles, etc.) and other forms of information. Although described below with regard to “receiving content,” this is not limiting to one way transfer of information, as the term also means the two-way exchange of data as would happen with a user playing a video game or solving an online puzzle, for example.

As described herein, the terms “user” “end user” and “customer” can be used interchangeably to describe any person, group or legal entity who is utilizing the presently described system to interact with a content provider and/or to perform cryptocurrency mining activities through the interaction.

As described herein, the term “mining activities” and “mining operations” can be used interchangeably to include any activities performed on, within or to a blockchain ledger system and/or coin mining network utilizing the presently described system. More specifically, the mining activities can include actions utilizing a user's computer components and/or specialized hardware (e.g., ASIC) to facilitate proof of work and/or validate blockchain transactions in order to generate cryptocurrency. Mining Activities can include the process of solving math puzzles to verify transactions (e.g., ensuring the transactions are not false), and/or participating in the addition of new blocks to a blockchain network in any number of different industries, such as smart: contracts, payment processing, money transfers, monitor supply chains, retail loyalty rewards and programs, digital Identification, Data sharing, Copyright/Royalty protection, Digital voting, Real estate/land/auto title transfers, Food safety, Immutable data backup, Tax regulation/compliance, Workers rights, Medical recordkeeping, Weapons tracking, Wills/inheritance, Equity trading, Managing IOT (internet of things) networks, Expediting energy futures trading/compliance, Securing access to belongings, and/or Tracking prescription drugs, among others, for example.

As described herein, the term “mining network” can include the specific blockchain network on which a particular cryptocurrency such as Ethereum, Bitcoin, Dogecoin, Litecoin and others are held, exchanged and/or created, and can include any number of hardware and software components through which mining activities can be performed on the mining network.

As described herein, the term “platform provider” can include the individual, group or legal entity that is providing the functionality to enable users to perform the cryptocurrency mining activities through their participation with a content provider.

In one preferred embodiment, various aspects of the methods and systems described herein can be called “Project Mercury” and can utilize the Ethereum Network to mine Ether. Of course, other embodiments are contemplated wherein the same or a different platform provider can utilize another type of mining network to mine for a different type of cryptocurrency.

In either instance, a method and system for delivering content and conducting cryptocurrency mining operations can function to harness the decentralized computing power of an unlimited number of users to conduct mining operations while the users are enjoying content from a content provider. Upon completion of the mining operation, each user can be compensated based on the amount of work their hardware contributed.

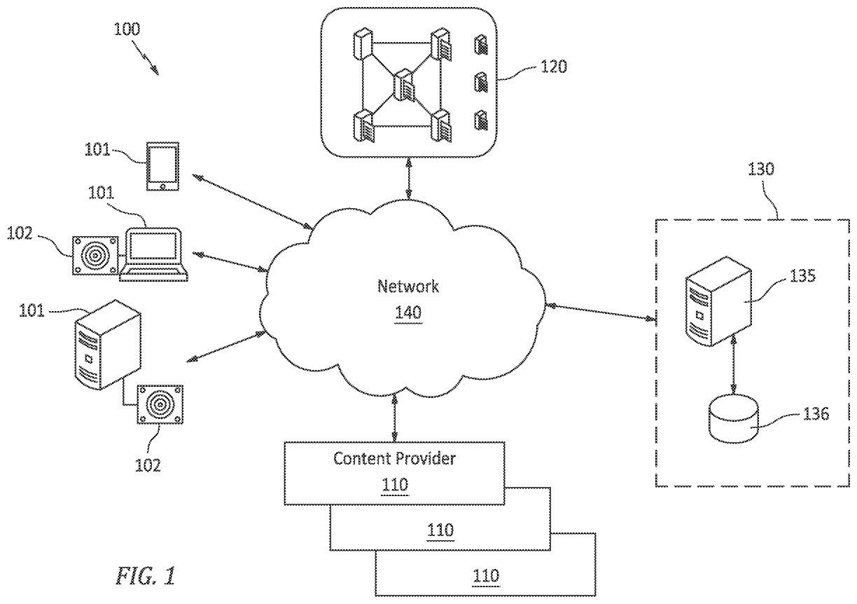

FIG. 1 is a schematic illustration of an exemplary system operating environment 100 for implementing a method for delivering content and conducting cryptocurrency mining operations. The system 100 can include, for example, any number of user interface devices 101 and 102, any number of content provider systems 110, any number of mining networks 120 and a platform provider system 130 that can be connected over a network 140.

Each of the user interface devices 101 can be any form of computing device such as a computer, tablet, smartphone, or other processor enabled device that can be operated by a human user. Moreover, each of the interface devices can also include one or more client applications, such as a web browser, for example, which can allow the user to communicate with and view content from other devices over the network 140.

In one embodiment, each of the user interface devices 102 can be an Application-Specific Integrated Circuit (ASIC) having a plurality of microprocessors that are designed for the sole purpose of conducting mining operations. As noted above, mining operations involves the solving mathematical equations, and the equations relating to each cryptocurrency are vastly different. As such, each ASIC device will preferably be custom built and encoded with instructions for solving equations for a single type of cryptocurrency. The ASIC can be communicatively linked directly to an interface device 101 belonging to the same user or can be in direct communication with other devices over the network 140.

Each of the content provider systems 110, according to one embodiment, can be associated with an individual content provider, and can function to send and receive content with any number of users via the user interface devices 101 through any number of different mediums such as a website, direct network connection, subscription network and the like, for example. In this regard, each of the content provider systems can include any number of individual computing devices such as various web servers, email servers, application servers, content servers, database servers and the like, for example.

Each of the mining networks 120, according to one embodiment, can include any type of software and hardware (e.g., computing devices) that can be in communication with the system components over the network, in order to form the requisite nodes for conducting mining operations of a designated cryptocurrency.

The platform provider system 130, according to one embodiment, can include any number of computing devices 135 and databases 136 on which various portions of the method can be performed. The platform provider system can function to provide a central hub for controlling the communication between the user interface devices 101-102 of each user, the content provider systems 110, and the mining network 130, for example. Additionally, the platform provider system can generate and distribute operating instructions for each of the above noted system components to perform in order to perform the methodology described herein.

In this regard, portions of the method can be implemented as a computer program product, i.e., a computer program tangibly embodied in a non-transient machine-readable storage device, for execution by, or to control the operation of, a data processing apparatus. The computer program can be written in any form of computer or programming language, including source code, compiled code, interpreted code, scripting code (e.g., JavaScript) and/or machine code, and the computer program can be deployed in any form, including as a stand-alone program or as a subroutine, element, or other unit suitable for use in a computing environment.

As noted above, each of the platform provider system, the content provider systems and the mining networks may include any number of individual databases that can function to receive and store any form of information. As described herein, each database can include any type of computer-readable storage mediums, including all forms of volatile and non-volatile memory such as, for example, semiconductor memory devices, e.g., DRAM, SRAM, EPROM, EEPROM, and flash memory devices; magnetic disks, e.g., internal hard disks or removable disks; magneto-optical disks; and optical disks, for example.

As described herein, the network 140 can include any type of transmission medium that facilitates any form of digital or analog communication (e.g., a communication network). Transmission mediums can include one or more packet-based networks and/or one or more circuit-based networks in any configuration. Packet-based networks can include, for example, the Internet, a carrier internet protocol (IP) network (e.g., local area network (LAN), and/or a wide area network (WAN). Circuit-based networks can include, for example, the public switched telephone network (PSTN), a cellular or wireless network (e.g., RAN, code-division multiple access (CDMA) network, time division multiple access (TDMA) network, global system for mobile communications (GSM) network), infrared transmissions, Blue Tooth or Personal Area Networks (PANs), Near Frequency Communication (NFC) network, and/or other circuit-based networks.

Information transfer over the network 140 can be performed by a communication module based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), a Global System for Mobile Communications (GSM) protocol, a Push-to-Talk (PTT) protocol, a PTT over Cellular (POC) protocol, a Real-time Messaging protocol (RTMP), a Real-time Media Flow Protocol (RTMFP) and/or other communication protocols.

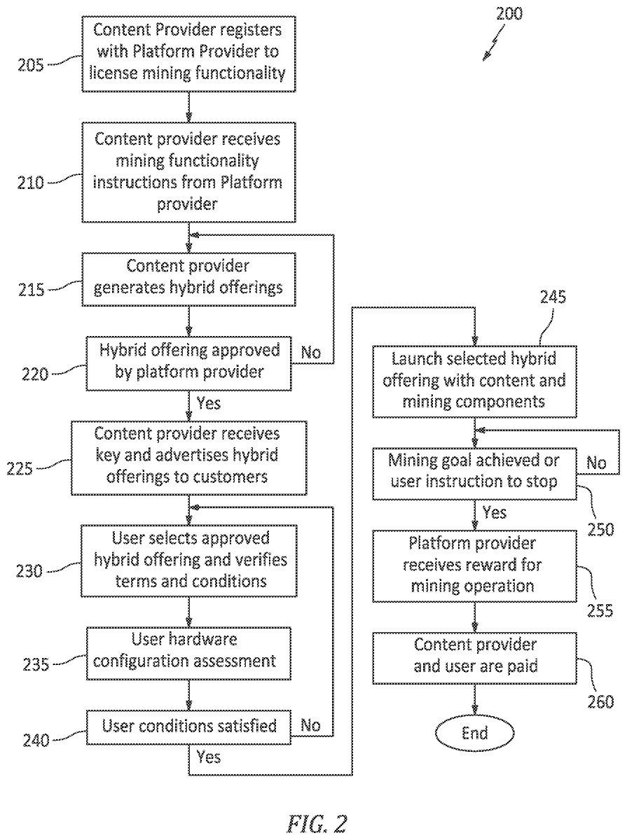

FIG. 2 is a flowchart providing a representation of an exemplary method 200 for delivering content and conducting cryptocurrency mining operations using decentralized online platforms, that is capable of being implemented within the system 100. Although described below with regard to particular method steps, this is for illustrative purposes only, as the steps can be performed in any order, and can also include any number of different steps, in order to achieve the inventive concepts disclosed herein. Moreover, while the methods illustrated and described below can be implemented by (and in some cases, are described with respect to) the system 100 of FIG. 1, (or components thereof), these methods and/or method steps may also be implemented utilizing any suitable hardware implementation, which may be different from the described system architecture.

The method can begin at step 205, wherein a content provider can undergo a company registration process with the platform provider. This registration process can include the exchange of any type of information that may be required by the platform provider. Several nonlimiting examples may include a financial agreement, software licensing agreements, terms and conditions of service, general contractual terms, risk mitigation, and/or technical information such as network configuration details, among others. In one embodiment, the registration process can be conducted by the content provider system 110 and the platform provider system 130 over the network 140.

Upon successful registration by the content provider, the method can proceed to step 210 wherein the content provider system 110 can download or otherwise receive a set of instructions from the platform provider system 130.

In one nonlimiting embodiment, the set of instructions can include a Software Development Kit (SDK) for conducting mining operations using Ethereum Client also referred to as node that is able to parse and verify new transactions, execute smart contracts, and find new blocks for the blockchain. To this end, the instruction sets can function to communicate with the mining network 120, sync with the mining network, perform transaction validation, block validation, create new blocks, perform proof or work, and/or fetch rewards for the same.

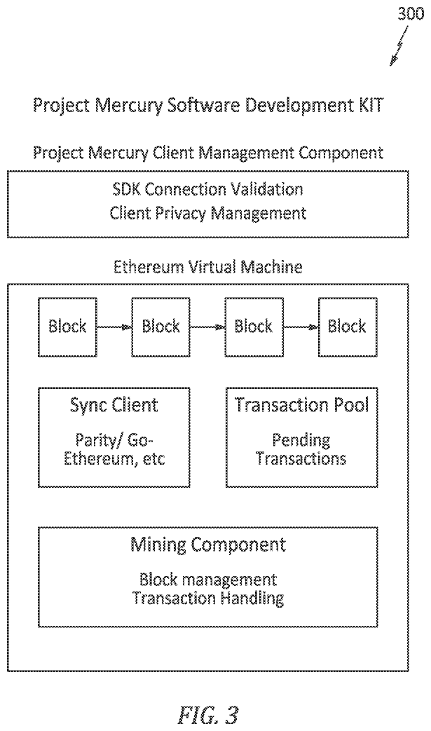

As shown at FIG. 3, the exemplary SDK can include a client management component 300 and can provide any number of interfaces to create transactions and mine blocks which is the key for any Blockchain interaction.

Of course, the set of instructions are not to be construed as limited to a software development kit for conducting mining operations on the Ethereum client network, as the set of instructions can include, comprise, or consist of any type of programmatic instructions in any format or language containing any number of hardware tools and software tools such as various libraries, documentation, code, code samples, processes, guides and/or programs to enable customers of the content provider to perform cryptocurrency mining operations under the control of the platform provider system on any number of different mining networks.

Next, the method can proceed to step 215 where the content provider can create any number of hybrid offerings each containing a content component and a mining component. The goal of the hybrid offerings is to keep customers entertained for a period of time sufficient for the customer's computer to perform and/or complete a specific mining operation. As will be described below, in the preferred embodiment, the mining component and content component can be designed to operate simultaneously such that one will not end before the other unless instructed to do so by the end user.

To this end, the content component can include any type of one way or two-way content that can be sent or exchanged with or between the content provider system 110 and the user interface device 101 of the customer over the network 140. For example, if the content provider is an online gaming company, the content component of the hybrid offering can include a quest whereby users play a game with the goal of finding and destroying an enemy such as a dragon or other such villain. Likewise, if the content provider is a music service, the content component of the hybrid offering can include playing a specific number of songs, etc.

The mining component of the hybrid offering includes the outcome of the instructions sent from the provider platform to the content provider at step 210. In other words, the mining component can include instructions for execution by the user's hardware 101 and/or 102 to conduct cryptocurrency mining activities under the supervision, guidance and/or control of the platform provider system 130.

At step 220, the content provider system 110 can submit the hybrid offering generated at step 215 to the platform provider system 130 for approval. The approval process by the platform provider can include any number of steps and/or details for ensuring a successful experience by the end user and compliance by the content provider with any terms and conditions imposed by the platform provider.

Several nonlimiting steps which may be undertaken during the approval process include, but are not limited to, 1) confirming the successful integration and operation of the mining component bearing the cryptocurrency mining instructions within the hybrid offering; 2) verify the absence of malicious software such as computer viruses, tracking components or malware within the hybrid offering; 3) verify that the content component of the hybrid offering is not so hardware intensive that an average user device 101 would not have sufficient resources to conduct the mining operations; and/or 4) verify the subject matter of the content does not violate any rules of the platform provider or contain prohibited or illegal material.

If the hybrid offering is rejected by the platform provider, the method can return to step 215 and the content provider can revise the offering before trying again.

Upon approval of the hybrid offering, the method can proceed to step 225 where the platform provider system 130 can assign a unique key, token, or other designation to the offering. The key can then be inserted into the software of the hybrid offering to ensuring no additional changes are made, and the content provider can then begin advertising the approved hybrid offering to its customers.

At step 230, a customer of the content provider system can select the approved hybrid offering. Upon selection, the customer can be provided with an end user agreement to ensure the user understands that they are about to participate in mining operations while experiencing content. The user may be required to verify they have read and understand the agreement along with any other terms and conditions before being able to continue.

Upon acknowledgment by the user, the method can proceed to step 235, wherein the user's hardware configuration can be scanned or otherwise provided to the content provider system 110 to determine if the user's interface device(s) meet the minimum standards for participation in the selected hybrid offering.

For example, the hardware configuration can determine if the user has an ASIC device 102 connected to their interface device 101, along with 1) the type, speed, and number of central processing units (CPU)'s on the user interface device; 2) the type, speed and number of graphics processing units (GPU)'s on the user interface device; and/or 3) the amount of available memory on the user interface device.

If the user does not have an ASIC interface device, the system can provide the user with options for obtaining one through the platform provider 130 or the content provider 110. As noted above, ASIC interface units 102 are custom build hardware components that are optimized for performing mining operations. To this end, the ASIC provided by the methodology can advantageously be optimized for use during hybrid offerings, thus allowing the end user to enjoy all hybrid offerings at maximum performance while achieving maximum mining rewards.

In addition to the above, the user can be provided with options for customizing or limiting the amount of system resources to be used by the hybrid offering. For example, the user can designate or limit maximum CPU percentage usage, GPU percentage usage, Memory percentage usage and ASIC percentage usage.

Moreover, the user can select whether they want the mining operations conducted by their hardware component(s) to be performed in a standalone capacity or as a part of a mining pool. Participating in a mining pool will increase the chances and time necessary to achieve a mining operation goal such as finding a block at the group level. Users of a mining pool are able to combine their individual computational resources while experiencing the content provided by the content provider together (e.g., playing the exemplary video game).

In one embodiment, a mining pool coordinator can be assigned with functions that involve managing the pool members' hashes, looking for rewards through pooled efforts of available processing power, recording work performed by each pool member, and assigning reward shares to each pool member in proportion to the work performed after suitable verification. Users who opt to participate in a mining pool may also be assigned to a pool of pools, to further enhance output.

In either instance, at step 240, the content provider system 110 can ensure that all mandated user terms and conditions outlined at steps 230 and 235 are satisfied. If any conditions are not met, the method can return to step 230.

At step 245, the content provider system 110 can launch the hybrid offering to the user via the user interface devices 101 and 102. More specifically, the content provider system can communicate the content with the user interface device 101 over the network, and the provider platform system 130 can conduct mining operations with the user interface devices 101 and/or 102 as designated by the user.

Once the hybrid offering has begun, the method can proceed to step 250 where the platform provider system 130 and the content provider system 110 will communicate to ensure simultaneous operation of the mining component and content component until either the end user instructs the system to stop or until a particular milestone, goal or accomplishment of the mining operation has been achieved.

Upon reaching a designated goal such as completing a proof of work activity, for example, the platform provider system 130 will send a notification to the content provider system 110 that it is relinquishing control of the user's hardware 101 and/or 102 and terminating the mining component of the hybrid operation. Upon receipt of this notification, the content component can initiate an end sequence to conclude the content.

For example, if the selected hybrid option is the video game described above, the player (or players if the users opted to join a mining pool) will only be able to find and/or defeat their opponent when the mining operation has concluded. To this end, the difficulty level and/or time necessary for the end user to complete the game will appear to be natural to the user but will in fact be controlled by the outcome of the mining component.

At step 255, the platform provider will receive a reward for the performance of the mining operation. The reward will be a in the form of the cryptocurrency to which the mining operation was directed.

Finally, at step 260, the platform provider system 130 can provide payment to the content provider and the user. To this end, payment to the content provider can be in conformity with the registration agreement outlined at step 205 and can be in any number of different standard or digital currencies.

In the preferred embodiment, the user can be paid with digital currency that is different from what was mined and awarded at step 255. The payment to the user will have a value that is equivalent to the amount of processing power their devices 101 and/or 102 contributed to the mining operation. To this end, users who contributed less computational power will be paid less than users who contributed more processing power of the same amount of time.

In the preferred embodiment, the user can be paid with a digital currency called Mercury Metal that is supplied by the platform provider system 130. The Mercury Metal can be deposited into the user's digital wallet or account with the content provider and can be subsequently used the same way as any other digital currency. To this end, the customer can use or convert the Mercury Metal to other currency options for use with the content provider or other merchants.

Accordingly, the above-described system and method steps provide a novel means for allowing a user to profit from cryptocurrency mining operations while experiencing content from a content provider that is not rendered obvious by any known art.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, aspects of the present invention may be embodied as a system, method, or computer program product. Accordingly, aspects of the present invention may take the form of an entirely hardware embodiment, or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for delivering content to a user and conducting cryptocurrency mining operations, the method comprising:
establishing communication between a platform provider system, a content provider system, a cryptocurrency mining network, and a user interface device;
providing, via the platform provider system, a set of mining instructions to the content provider system;
generating, via the content provider system, a hybrid offering, said hybrid offering including a content component and a mining component that includes the mining instructions; and
executing the hybrid offering on the user interface device,
wherein the content component transmits content between the content provider and the user interface device over a communications network, and
the mining component utilizes the user interface device to conduct a cryptocurrency mining operation on the cryptocurrency mining network.

2. The method of claim 1, wherein the mining component is controlled by the platform provider system.

3. The method of claim 1, wherein the transmitted content includes one way transmission from the content provider system to the user interface device.

4. The method of claim 3, wherein the transmitted content includes at least one of a video file, an audio file, streaming video, or streaming audio.

5. The method of claim 1, wherein the transmitted content includes two-way transmissions between the content provider system and the user interface device.

6. The method of claim 5, wherein the transmitted content includes an interactive game.

7. The method of claim 1, wherein the content provider undergoes a registration process with the platform provider before receiving the set of mining instructions.

8. The method of claim 1, further comprising:
providing, via the platform provider, a unique token for insertion in the hybrid offering.

9. The method of claim 8, wherein insertion of the token in the hybrid offering prevents changes to the hybrid offering.

10. The method of claim 8, wherein the token is provided after an approval process by the platform provider.

11. The method of claim 10, wherein the approval process includes a confirmation by the platform provider that the mining component is functional.

12. The method of claim 10, wherein the approval process includes a confirmation by the platform provider that the mining component contains no malware.

13. The method of claim 10, wherein the approval process includes a confirmation by the platform provider that the content component does not occupy more than a predetermined percentage of a system resource availability of the user interface device.

14. The method of claim 1, wherein the cryptocurrency mining operation is performed by the user interface device in a standalone capacity.

15. The method of claim 1, wherein the cryptocurrency mining operation is performed by the user interface device in association with a mining pool.

16. The method of claim 1, further comprising:
achieving, via the mining component, an end goal of the cryptocurrency mining operation.

17. The method of claim 16, further comprising:
receiving, via the content provider system, a notification of cryptocurrency mining operation completion.

18. The method of claim 17, further comprising:
initiating, via the content provider system, an end sequence to conclude the operation of the content module on the user interface device.
